(19) United States
(12) Patent Application Publication
(10) Pub. No.: US 2006/0008912 A1
(43) Pub. Date: Jan. 12, 2006

(54) Temporary visual indicators for paint and other compositions

(76) Inventors: Patrick Leo Simon, Lakeville, MN (US); William Toreki III, Gainesville, FL (US); Patrick G. Fischer, Falcon Heights, MN (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/177,538

(22) Filed: Jul. 8, 2005

Related U.S. Application Data
(60) Provisional application No. 60/586,551, filed on Jul. 9, 2004.

(51) Int. Cl. G01N 31/00

(52) U.S. Cl. 436/5; 436/166

(57) ABSTRACT

The present invention concerns novel methods and compositions useful for providing a temporary visual indication of the location, concentration, and/or time period of treatment of an applied material. The subject invention provides compositions and methods that use a temporary visual indicator. In certain embodiments, the temporary visual indicator is a pH sensitive visual agent (i.e., dye) that can be added either alone or in combination with other visual agents and/or pH modifying agents. In related embodiments, compositions of the invention comprise a combination of at least one pH modifying agent and at least one pH-sensitive visual agent.

### CROSS-REFERENCE TO A RELATED APPLICATION

This application claims the benefit of U.S. provisional application Ser. No. 60/586,551, filed Jul. 9, 2004, the disclosure of which is incorporated herein by reference in its entirety.

### BACKGROUND OF THE INVENTION

There are many situations in which it is desirable to know where a particular material is being applied or has previously been applied.

When painting a surface with the same or a like color, it is often difficult to distinguish between areas that have been painted and areas to be painted. This is particularly difficult when painting ceilings and walls because of shadows and poor light conditions. Therefore, it is easy to miss spots that still need to be painted and/or to accidentally paint the same area over again.

As exemplified in U.S. Pat. Nos. 5,532,029 and 5,548,010, paints can be provided with a means for changing color over time so that the location of the applied paint is discernible at the time of application. The U.S. Pat. No. 5,548,010 discloses a paint that changes color as a result of a light-unstable dye that is mixed with the paint. The light-unstable dye provides a secondary color to the paint, which dissipates over time.

U.S. Pat. No. 6,120,949 discloses the addition of a light-stable colorant for paint that is mutable when exposed to a specific, narrow band-width radiation, such as ultra-violet (UV) radiation. The colorant can be added to paint compositions for application to a surface. The colorant will present a specific color until presentation with UV irradiation to irreversibly mutate the color to become substantially colorless. UV radiation, however, can be hazardous to health. For example, UV radiation exposure can cause erythema, photoaging, skin cancer, and photokeratitis. Natural sunlight contains significant UV radiation; however, indoor lighting generally does not, making the method unsuitable for indoor use.

In a related application, U.S. patent application No. 2003/0191036 discloses a soap having properties (i.e., color, viscosity, smell, temperature) that change in a specific period of time to notify the user that the time has passed. In particular, the use of a food dye in an antibacterial soap with ascorbic acid and iron chloride as a “decolorizing agent” are described in the application. The antibacterial soap changes from a green color to a blue color, depending on the concentration of the decolorizing agent, within a specified period of time so that the user can monitor the amount of time spent scrubbing with the soap.

An adhesive compound which undergoes color changes upon application has previously been described (U.S. Pat. No. 4,954,544). The indicator affecting the color change in the adhesive also serves to enhance the physical characteristics of the adhesive compound by contributing to improved adhesive flow and bonding. The indicator also adds to the economy of the product by allowing for formulations in which less adhesive compounds are required, while still imparting improved flow and bonding. The disclosed indicator, however, does not solely provide the function of being a temporary visual guide for application of a material to a surface.

Also, U.S. Pat. Nos. 6,139,821; 5,997,891; 5,837,645; and 5,523,075 disclose compositions, in particular sunscreens, in which a pH-dependent indicator is included, where the indicator is visible at a first pH and invisible at a second pH.

Several commercial pH indicators (see Swiss Patent No. 464,415; Japanese Patent Application No. 59-26666; U.S. Pat. No. 5,997,891; and European Patent Application Publication Nos. 0549145; 0488980; and 1400574) are currently available. However, such indicators (i.e., phenolphthalein, or thymolphthalein) are not practical for use in most latex-based products (such as latex paints) because of the high pH range at which the visible color change occurs.

For example, phenolphthalein (PTL) has a transition from colorless to pink over the pH range of 8.2 to 10. The pH transition range of PTL, or any other pH indicator, represents an interval where the overall color and color intensity are defined by contributions from both the acid form and base form of the indicator. Thus, for optimal efficiency and stability of the first color, the initial pH must be close to, and preferably in excess of, that which causes the indicator to exist primarily in the desired form. In the case of PTL, the pink color is the desired first (temporary) color, thus the pH must be kept greater than 10 to ensure that the pink color intensity is maximized. At lower pH (9 for instance) an excessive amount of PTL would be needed to produce an intense color.

Furthermore, the pH of a latex paint formulation starts to decrease immediately as the paint begins to dry. This drop can be caused by loss of volatile compounds, which results in a rapid shift of the color equilibrium to the colorless form when using PTL. Thus, in order to prolong the desired pink color, additional basic compounds must be added, and this would cause the pH to be even higher (11 or above) and be dangerous to the user.

The chemical equilibrium between the colored and colorless forms of PTL is also affected by the loss of water as the paint begins to dry. Again, the pH must be increased above the high limit of the transition range in order to compensate, otherwise the discernable color dissipates at a rate that is undesirable for use with latex paints. Testing has shown that with formulations using phenolphthalein with AMP 95 amine for pH adjustment, the pink color dissipates too quickly (on the order of one to two minutes) for effective use, even though the initial pH was close to 11. This is certainly inadequate, as the color can be gone before the paint roller can be reloaded for a second pass across a surface (such as a ceiling). Moreover, the high pH value can be harmful to the user's health.

It is well known that paints are carefully formulated to ensure stable emulsions and meet specific performance criteria such as viscosity, proper leveling to remove brush marks, durability, adhesion, flexibility, shelf life, and other important factors. Any significant change to the pH (i.e., addition of pH modifiers such as bases or volatile amines) of these carefully formulated systems can lead to unacceptable degradation of such properties. Latex paints are generally formulated with a pH of between 8 and 9. Thus, the high pH (10-11) required for using PTL or other similar pH-based indicators described in the patents cited above clearly may cause severe changes to the desirable properties of the paint.

Latex paint formulations, in general, vary widely. Different manufacturers use different latex resins, different pigments, fillers, plasticizers, solvents, and other ingredients. These various paint chemistries can affect the behavior of a pH indicator in terms of color intensity, color duration, residual tint, and stability. In addition, common pH modifiers often adversely affect the nature of latex paint formulations (such as changes to the color or viscosity of the paint).

Moreover, the pH of latex-based paints in general is unstable over long periods of time after manufacture. For example, it would not be unexpected for a latex-based paint, which originally had a pH of about 8.5-9.5 at manufacture, to have a pH level below 8.0 before customer purchase. Thus, a pH indicator that was added to a latex paint at the time of manufacture (i.e., pH indicators that are detectable at a pH range of 8.5 to 9.5), would not provide an effective visual guide as a result of the paint's unstable pH levels over time (i.e., drop in pH to below 8.0).

Finally, health and safety considerations are also important factors in adding the pH indicators described above. For example, materials with pH levels above 10 are likely to cause significant skin or eye irritation in the event of accidental exposure. Moreover, higher pH paints can expose the user to harmful levels of volatile organic compounds. This may be caused by the addition of volatile organic amines such as AMP-95, which are commonly used to adjust (raise) paint pH. In addition, harmful levels of volatile organic compounds can be released from such paints as a result of the higher pH. Ensuring low volatile organic compound levels is especially important to paint manufacturers in view of new EPA regulations effective in 2006 requiring volatile organic compound levels of less than 50 g/liter of flat latex paint.

Other situations in which a temporary visible indicator would be useful include, and are not limited to, inks for writing or printing, clear lacquers, varnishes, epoxies, or sprays; pesticides, herbicides, or fertilizers; topical formulations (i.e., lotions, creams, gels and/or sprays); cleaning solutions; protective sealants (i.e., carpet or fabric protective sealants); polish or wax solutions for vehicles (i.e., car, boat); and the like. With all of these materials, it is advantageous, or even critical, to know precisely where the material is being applied or has previously been applied. Unfortunately, these materials often do not include a means for helping the user differentiate areas to which material application is being applied or has already been accomplished.

### BRIEF SUMMARY OF THE INVENTION

The present invention provides novel methods and compositions useful for providing temporary visual indication of the location, concentration, and/or time period of treatment of an applied material.

The compositions of the subject invention include a temporary visual indicator. In certain embodiments, the temporary visual indicator is a pH sensitive visual agent (i.e., dye) that can be added either alone or in combination with other visual agents and/or pH modifying agents. In related embodiments, compositions of the invention comprise a combination of at least one pH modifying agent and at least one pH-sensitive visual agent.

According to a preferred embodiment of the present invention, compositions and methods are provided for use with latex-based products, in particular latex-based paints, which effectively produce a temporary change in color that is easily detected by the user. The subject invention optimizes the color dissipation rate of temporary visual indicator(s) so that the contrast in color is visible to the user for longer periods of time than that of previously disclosed indicators.

In one embodiment, the present invention provides compositions and methods for use with materials requiring a temporary visual indicator (i.e., paints (latex), waxes, lacquers) in which a strong color intensity is provided without exposing the user to health afflicting levels of volatile organic compounds.

In a specific embodiment, a pH sensitive visual agent and a pH modifying agent are provided to a latex-based paint. The pH modifying agent is preferably a volatile acid or base. The skilled artisan would readily recognize the appropriate amount of pH modifying agent to be added to the paint to raise or lower the pH to a desired level. In a related embodiment, the effective amount of volatile pH modifying agent that is added is the amount sufficient to induce approximately a 1.00 pH unit change in the pH of the latex-based paint to be treated.

In one example that uses a non-volatile pH modifying agent, 4.44 g of 3M KOH solution is added to 400.00 g of latex paint (original pH=8.59) to raise the pH to 9.95. In another example that uses a volatile pH modifying agent, 400.00 g of latex paint (original pH=8.59) was raised to a pH of 10.18 by the addition of 5.40 g of Advantex (a volatile amine).

In another embodiment of the invention, a pH sensitive dye is added, either alone or in combination with other dyes (either pH sensitive or non-pH sensitive) and/or pH modifying agents, to a latex-based material to provide a temporary visual indicator as well as to affect the final color tone of the material. For example, certain pH sensitive dyes can vary the tone of a white latex-based material by virtue of the pH of the material.

In another embodiment, the invention concerns new temporary visual indicators. According to the present invention, novel combinations of pH sensitive dyes are used to provide new temporary visual indicators that exhibit longer dissipation periods (as compared to currently available indicators) while offering an aesthetically pleasing end product.

In yet another embodiment, the subject invention provides compositions and methods for making customized materials for application to a desired surface. Customization of materials, according to the invention, includes the steps of selecting a latex-based material for application to a surface; assessing the pH level of the selected material; selecting a pH sensitive temporary visual indicator; selecting a pH modifying agent; and mixing the temporary visual indicator and the pH modifying agent into the material to form a customized composition. The customized composition can then be applied to the surface in accordance with user needs.

### DETAILED DISCLOSURE OF THE INVENTION

The present invention concerns improved latex-based materials that are readily discernable during and/or after application to a surface. Compositions of the invention include at least one temporary visual indicator that provides a detectable contrast for the user to distinguish the location, concentration, and/or time period of an applied material, without interfering with the nature of the material. In a preferred embodiment, at least two temporary visual indicators are provided to a latex-based paint.

In a method of use, a material is selected for which a detectable contrast is desired; and a temporary visual indicator is added to the material. The temporary visual indicator can be added to a material prior to and/or during application of the material to the surface.

It is advantageous to define several terms before further describing the invention. It should be appreciated that the following definitions are used throughout this application.

Definitions

As used herein, the term “material” refers to any substance that can be applied to a surface. Examples of materials of the invention include, but are not limited to, paints, stains, epoxies, varnishes, lacquers, waxes, glues, fertilizers, weed control products, products used to coat a surface (i.e., protectants), cosmetics, lotions, medicines, and inks. Preferred materials of the invention are latex-based paints, stains, epoxies, varnishes, lacquers, and waxes.

The term “surface,” as contemplated herein, refers to an outer boundary of an object. Non-limiting examples of surfaces to which materials of the invention are applied include, but are not limited to, walls, floors, skin, vehicular exterior and interior surfaces (i.e., automobile, boats, trains, airplanes), furniture, appliances, glass, wood, plastic and other synthetic materials, metal, bodily organs (including skin, hair, nails, teeth, internal organs), leather, paper, canvas, and mirrors.

As used herein, the term “dry” refers to a characteristic of materials of the invention after application to a surface, where the material is free from liquid or moisture. With regard to paints, the term dry refers to “set-to-touch.” As understood by the skilled artisan, the majority of latex paints, when applied at room temperature, will be dry or “set-to-touch” within one hour or less after application. However, poor ventilation, low temperatures, thick films, and high humidity can increase the time necessary for a latex paint to dry.

In accordance with the present invention, a temporary visual indicator is any substance that is readily visible for a period of time as desired by a user. The temporary visual indicator, when mixed with a selected material for application to a surface, preferably does not adversely affect the nature of the material. In certain embodiments, the temporary visual indicator will, within a desired period of time, become undetectable (such as invisible and/or colorless). In other embodiments, the temporary visual indicator is readily discernable for a period of time, after which the indicator is no longer readily discernable but may still affect a desired aesthetic appearance in the material (such as undertone or aftertone in paint).

The temporary visual indicator, according to the present invention, can be a visual agent (or dye) that imparts a color for a set period of time. As used herein, the term “color” includes colors of all shades, hues, and intensities visible to the naked or assisted eye. Color changes of an indicator may be triggered by a variety of physical or chemical reactions. The presence of certain gases, changes in H₂O concentrations (i.e., humidity, moisture level), changes in temperature, or exposure to UV light may all be used in compositions and/or methods of the invention to affect color changes of certain temporary visual indicators.

In one embodiment, the temporary visual indicator is a pH sensitive visual agent that imparts a first color at a first pH level and is colorless or imparts an acceptable second color at a second pH level.

In a preferred embodiment, where the material is a latex-based paint product, contemplated pH sensitive visual agents that can be added to the paint in accordance with the invention include, but are not limited to, dibromo-o-cresolftilfonphthalein or bromocresol purple (BCP); phenolfulfophthalein or phenol red (PR); cyanine (Qunioline Blue); nitrophenol; phenolphthlaein (PTL); naptholphthalein; o-cresolphthalein; bromothymol blue; dibromophenolsulfonphthalein or bromophenol red; bromophenol blue; methyl red; bromocresol green; methyl orange; and m-cresol purple. The corresponding partially or wholly neutralized salts of these compounds may also be used. Additional common pH sensitive dyes include those disclosed in The Merck Index, tenth edition, published by Merck & Company, Rahway, N.J., 1983, pages MISC-104 to MISC-105.

For materials such as latex-based paint products, indicators such as BCP, PR, and cyanine are particularly desirable due to their pH color transition range, which is similar to existing pH ranges of most latex paint formulations. Most preferably, according to the present invention, BCP and PR (and their partially or wholly neutralized salts) are used in combination as temporary visual indicators in a latex-based paint product.

According to the subject invention, the temporary visual indicator(s) can be added to a selected material with other components that affect the visibility and/or duration of visibility of the indicator to the user. In certain embodiments of the invention, pH modifying agents are added to materials in combination with the temporary visual indicator(s). For example, oxidizing or reducing agents may be added to a material with an indicator to affect the visibility of the indicator, i.e., to increase the intensity of the indicator color and/or to make the indicator color dissipate in minutes, hours, or days.

The pH modifying agent(s) are used to change the pH of the material and enable user detection of the temporary visual indicator(s). Specifically, upon addition of a pH modifying agent, a first pH is established in the material composition. Within a specified (or desired) period of time, the pH modifying agent degrades, evaporates, or otherwise effects a change in the pH of the composition to a second pH, in conjunction with any solvent and/or water evaporation that occurs as the material (such as paint) dries. Depending on the specific transition phase of the temporary visual indicator, it is discernable at the first pH and no longer discernable at the second pH (after evaporation, degradation, etc. of the pH-modifying agent). A pH modifying agent can be added prior to, during, and/or after addition of a pH sensitive visual agent to the paint.

Reference to degradation or evaporation of a base or acid with regard to changing pH is directed to a chemical conversion or reaction. For example, in the case of a volatile base such as ammonia or organic amine, the pH is lowered simply by evaporation of the compound. For a non-volatile agent such as KOH, a chemical conversion/reaction takes place when the paint absorbs carbon dioxide thereby reducing the OH⁻ concentration and, consequently, the pH level. With this example, the CO₂ may be supplied directly or simply absorbed from ambient air. pH modifying agents contemplated for use in accordance with the subject invention include volatile compounds such as, but not limited to, volatile bases (i.e., monoamines such as ammonia, methyl amine, dimethylamine, trimethylamine, ethyl amine, isopropyl amine, butyl amine, pentyl amine, hexyl amine, and octyl amine, diamines such as ethylene diamine, 1,2-diaminopropane, 1-3-diaminopropane, and 1,2-diaminobutane, and cyclic amines such as tetrahydropyrrole) and volatile acids (i.e., hydrochloric acid or thionyl chloride). Alternatively, pH modifying agents of the invention can be non-volatile compounds such as salts (i.e., sodium hydroxide or sodium carbonate).

The pH modifying agent(s) and/or pH sensitive indicator(s) of the invention can be selected for addition based on user health and safety considerations. For example, a non-volatile pH modifying agent may be selected for addition with a pH sensitive dye to a latex-based paint product in order to reduce the release of volatile organic compounds or to maintain non-hazardous pH levels (i.e., pH levels below 10).

In one embodiment of the invention, a latex paint product is provided that includes a temporary visual indicator that is a pH sensitive visual agent and a pH-modifying agent. By using a pH modifying agent, the pH level of the latex paint can be altered in order to affect the color, intensity of color, and/or color dissipation rate of the pH sensitive visual agent that is in the paint. In certain embodiments of the invention, ammonium hydroxide or 2-amino-2-methyl-1-propanol (AMP95) is added as a pH modifying agent to a latex-based paint product to achieve a desired pH range.

In other embodiments, rather than using a pH modifying agent, the amount and/or type of indicator that are added to a material are adjusted to affect pH ranges. Preferably, the amount and/or type of temporary visual indicator added to latex-based paints are adjusted to affect pH ranges to produce maximum color intensity in the latex paint.

In embodiments where the material is a paint, other ingredients can be added in addition to the temporary visual indicator(s). Paints generally are composed of four basic ingredients: pigment, binder, thinner and/or thickener, and additives. According to the subject invention, certain pigments used to increase paint opacity are added to latex-based materials of the invention to minimize any undertone or aftertone resulting from the addition of a temporary visual indicator. For example, undertone or aftertone resulting from the use of a temporary visual indicator in paint can be minimized by adding pigments that increase the level of whiteness, such as thermo-optic clays and titanium dioxide, or by adding materials such as carbon black and other toners that slightly darken the paint.

In other embodiments of the invention, a wetting agent (also referred to herein as a dispersant) such as potassium tripolyphosphate (KTPP) or tetrapotassium pyrophosphate (TKPP) is used in combination with other appropriate wetting agents normally included in latex-based materials (such as latex-based paints) to enhance not only paint performance but to aid in temporary visual indicator activity.

Advantageously, the temporary visual indicator(s) of the invention is discernible only temporarily and within a set period of time, depending on the needs/desires of the user. For example, where the material is a latex-based paint product, the user would most likely require that the temporary visual indicator be discernable up to the time at which the paint is dry after application to a surface. In such cases, the temporary visual indicator could have a color dissipation rate of about 10 minutes up to about 3 hours to provide adequate time for application.

The present invention also contemplates the use of a temporary visual indicator that has a short rate of color dissipation, such as about 30 seconds up to about 5 minutes. pH indicators with a transition interval close to the pH of a paint that is nearly dry are preferable, as they enable adequate working time for paint application (10 to 180 minutes).

According to the subject invention, the desired dissipation rate of detection of a temporary visual indicator is dependent upon the pigment volume concentration of the material used. In certain embodiments, the temporary visual indicators of the invention (such as BCP and/or PR) are particularly effective in latex-based paints that are at or above critical pigment volume concentration. As understood by the skilled artisan, the point where just sufficient binder (i.e., a polymer) is present to fill the voids between pigment particles in dry paint is known as the critical pigment volume concentration (CPVC). Below the CPVC there is sufficient binder for filling the voids and above the CPVC there is not.

In a preferred embodiment, BCP is added to latex paint. BCP has a pH range of 5.2-6.8, where BCP is visible as a yellow color below a pH=5.2 and is visible as a purple color above pH=6.8. Because of its pH range, BCP has a slow dissipation of color in latex-based paints, allowing the painter to see which areas have been painted for an extended length of time, or to paint an entire surface (such as a ceiling) before complete BCP color dissipation. In a related embodiment, BCP can be added to vinyl acrylics. BCP can also be added to acrylic and epoxy clear floor finishes, grout, and tile sealers as well as clear protectants for cars.

Another temporary visual indicator of the invention is cyanine (quinoline blue CAS# [523-42-2]). This indicator exhibits a color transition from blue to colorless as the pH is lowered from 8.0 to 7.0. The color produced when cyanine is mixed with a white latex paint at a concentration of 0.005% is a light blue color. This color persists for significantly longer than the commercially available phthalein derivatives; however, the color disappears completely upon exposure to visible light. This property is especially useful when a prolonged temporary color is desired. Combination of this indicator and related derivatives with the other indicators described above is also useful.

Yet another temporary visual indicator of the invention is phenol red (PR). This indicator has a pH range of 6.4-8.0, where PR is visible as a yellow color below a pH 6.4 and is visible as a red color above pH=8.0. Because of its pH range, PR dissipates in latex-based paints much sooner than BCP and, in certain instances, the PR may present a slight yellow aftertone in dried latex paint. To address the aftertone, certain latex-based compositions of the invention may include additional pigments, such as titanium dioxide, carbon black, or any other toners to disguise the yellow aftertone.

In one embodiment of the invention, a pH sensitive dye is added, either alone or in combination with other dyes (either pH sensitive or non-pH sensitive) and/or pH modifying agents, to a material to provide a detectable contrast for an established period of time as well as to affect the final color tone of the material. With such embodiments, the contrast is readily discernable for a set period of time, after which, either the pH sensitive dye, other dye(s), and/or pH modifying agents affect the aesthetic appearance of the material as desired by the user. In a related embodiment, a pH sensitive dye is added in combination with at least one other dye (either pH sensitive or non-pH sensitive) and/or pH modifying agent, to a material to provide an aesthetically pleasing detectable contrast and/or affect color dissipation rate. In certain embodiments, the addition of combined pH dyes (and/or modifying agents) also affects the final color tone of the material.

In accordance with the subject invention, dyes that exhibit a barely perceptible color in specific pH environments (i.e., BCP and PR in acidic form) can be added to a latex-based product (i.e., latex paint) to achieve a specific aesthetic appearance in the post-application latex-product (such as after the latex-based paint product has dried). In general, such dyes have substantially higher color intensities, as perceived by visual observation, in the basic form than in the acid form. This means that they can be used in relatively low concentrations to achieve a visually perceptible original color, and that the second color (after drying) is much less intense. Fortunately, this less intense final color (yellow, for instance) is, in general, barely perceptible in a white paint formulation. The result of the final appearance of the dried paint that is essentially white rather than yellow is unexpected, and is significant in that it allows these indicators with lower transition intervals to be used to produce paints that are useful during application as well as aesthetically pleasing after application to a surface.

The prior art describes the use of phenolphthalein and thymolphthalein as temporary visual indicators. This is intuitive, since these indicators are widely known to exist in a colorless form at low pH. One would not expect, based on published data; that indicators which are not known to have a completely colorless form (such as BCP or PR) would also be useful, let alone more useful, as temporary visual indicators. For instance, BCP is reported to be purple or violet at high pH, and yellow at low pH. It is unexpected that at a given concentration of BCP, the color intensity of the purple form could be sufficient to impart a visible purple color, while the corresponding yellow form is invisible or barely perceptible at the same BCP concentration.

Certain pH sensitive dyes can vary the tone of a white material based on the established pH of the material (i.e., the established pH of a latex-based paint after drying is normally basic). In one example, to achieve an aesthetic appearance of a “cool white,” the pH sensitive dye BCP can be added to a white latex-based paint. BCP is recognized in the chemical field to exhibit a purple color in a basic environment and a yellow color in an acidic environment. Because BCP has a substantially higher color intensity in a basic environment than in an acidic environment, relatively low concentrations of added BCP to latex paint can achieve a visually perceptible temporary color. Further, since dried latex paints generally exhibit a slightly basic pH, the amount of BCP added can be manipulated to induce a residual purple or blue BCP tint in the white paint so that a “cool” white is presented. A “cool white” color is known to the skilled artisan as a white color with a slight blue tint.

In another example with white latex paint, to achieve an aesthetic appearance of a “warm white,” the pH sensitive dye PR or bromphenol red can be added so that the white color that is presented after the paint has dried is a “warm” white. Both PR and bromphenol red exhibit a transition from a red color in a basic environment to a yellow color in an acidic environment. A “warm white” color is known to the skilled artisan as a white color with a slight red tint.

The present inventors have discovered that BCP and PR exhibit greater color intensity when in a basic environment than does phenolphthalein, when added to a latex-based material. Thus, a significantly lower amount of BCP and PR indicator is needed. This provides an economic benefit, and may reduce any untoward effects that the indicator may have on the physical properties of the material.

For instance, a concentration of 0.004% of PR in latex paint provides an easily discernable pink color, whereas a 0.1% concentration (or 25× more) of phenolphthalein is needed in latex paint to achieve the equivalent pink color intensity, even when the pH in the latex paint is raised to much higher levels. As noted earlier, since dried latex paints generally exhibit a slightly basic pH, the amount of PR or bromphenol red added can be manipulated to induce a residual very slight blue or red, respectively, tint in the dried white paint so that a “cool” or “warm” white, respectively, is presented.

In one embodiment, the temporary visual indicator is cyanine and the material to which cyanine is added is a glycol solution. In a glycol solution, cyanine presents a very slight blue after-tone. In a related embodiment, where the material to which cyanine is added is a sodium salt solution, cyanine presents a slight yellow after-tone in the glycol solution. pH sensitive dyes having similar pH transition ranges and colors compared to BCP or PR are not necessarily useful for varying the tone of a white material. For example, bromothymol blue is known to the skilled artisan to have a similar pH transition range as BCP, changing from blue to yellow. However, the intensity of blue color provided by bromothymol blue (BTB) in latex paint is less intense than that of BCP at similar concentrations, thus substantially more BTB indicator is required than BCP to affect the same color intensity. Since the second (final) color of BTB is yellow, the dried paint would have an undesireable dry color due to the increased amount of dye.

In a preferred embodiment, at least one pH modifying agent and at least two pH sensitive visual agents are added to a latex-based paint to provide a temporary change in color to the material without affecting the desirable properties of the material (i.e., durability, viscosity, flexibility, shelf life, etc.). Although it is generally desirable to maintain the pH of a paint formulation close to that for which it was originally formulated, it is permissible in the practice of this invention to add a small amount of volatile or nonvolatile compounds (i.e., base or acid) to slightly alter the pH of the paint formulation. As long as the pH change is relatively small (about 1.0 pH unit), this is expected to have very little effect on the properties described above, and may enhance the performance of the paint.

For example, when nitrophenol (displays a yellow color within pH ranges of 6.2-7.6 and clear otherwise in latex paint) is combined with BCP in latex paints. The synergistic activity of BCP and nitrophenol present an improved color contrast during paint drying and color dissipation. Specifically, a more appealing purple color is presented as a contrast color because of the nitrophenol yellow tint, as opposed to the grayish color that would otherwise be provided by BCP alone. The combination of BCP and nitrophenol may also create a brighter white after the paint has dried.

The present invention also provides novel materials and methods for preparing compositions having a temporary visual indicator customized to an individual user's needs, where the individual user adds at least one temporary indicator to a selected material so that the location, duration of visible indication, and/or concentration of the material after application to a surface can be determined by the individual user.

In one embodiment, the subject invention enables the user to make, at a minimal monetary and time expense to the user, customized materials that are temporarily discernible after application. According to the subject invention, methods for making customized materials for application to a surface comprise the steps of selecting a material and at least one temporary visual indicator, and adding the temporary visual indicator to the material to form a customized composition. The customized composition can then be applied to a desired surface, wherein the indicator is temporarily detectable by the user. The temporary visual indicator identifies to the user (or others) the location and/or concentration of the applied material and eventually becomes undetectable so that the material functions as intended.

According to the subject invention, a device or kit or any other packaging system can be supplied to a user, wherein the kit comprises at least one compartment that includes a temporary visual indicator as defined above. In certain embodiments wherein the presence of a modifying agent is contemplated, the kit can include a second compartment that includes the modifying agent as defined above. These kits can be equipped with instructions for mixing the temporary visual indicator and/or modifying agent with a desired material to prepare a customized composition for application to a surface.

The user may desire a material that is visibly discernible for a specified period of time (i.e., a wax product that is originally colorless but upon application to a surface, is visible to the user for a specified period of time to ensure adequate surface treatment, and eventually returns to the original colorless property so that the wax functions as intended). Accordingly, in certain embodiments of the invention, a user may customize a material to include a temporary visible indicator that is discernible for a specified period of time. For example, where a temporary visible indicator that is sensitive to pH is mixed with a user selected material, the amount and/or concentration of a pH-modifying agent can be adjusted by the user to customize the period of time in which the indicator is visible to the individual user after application of the mixture to a desired surface (or other location).

In one embodiment, the user adds a temporary visual indicator to materials to be applied to a desired surface, wherein the visual indicator is detectable at a first pH and invisible at a second pH. For example, the user can select a latex paint, and add to the paint a temporary visual indicator and a non-volatile base or acid, wherein the indicator is visible upon application to a desired surface while the volatile base or acid is present in the paint. A change in pH of the paint after the base degrades causes the indicator to no longer be visible. The visual indicator can be reactivated to its visible form by temporarily restoring the pH of the applied paint to the first pH. Further embodiments include user selection of at least one pH sensitive dye and/or pH modifying agent(s) based on any one or combination of the following preferences: (1) health and safety considerations; (2) final aesthetic appearance of applied material; (3) color contrast during temporary visual indication; and (4) performance properties of the materials.

Following are examples that illustrate procedures for practicing the invention. These examples should not be construed as limiting. All percentages are by weight and all solvent mixture proportions are by volume unless otherwise noted.

### EXAMPLE 1

### pH Values for Commercially Available Paints

Several different brands of flat white latex paint were purchased from local retail outlets in Gainesville, Fla., except as noted. An effort was made to purchase paint marked specifically for use on ceilings. The pH of each of these paints was measured using a Corning pH meter calibrated with phosphate buffer solutions of pH=7.00 and 10.00. The paint descriptions, and pH are listed below, note the abbreviation for each paint, as they are cited in subsequent examples:

ENT—Enterprise interior one-coat latex flat wall paint, white # 758, pH=8.05

ACE—ACE flat wall paint, acrylic latex #1 84A3 10 Ultra White pH=7.57

GLD—Glidden GC1070 ceiling paint, white, pH=7.71

AT—American Tradition acrylic latex flat ceiling paint, pH=8.81

BR—Behr interior flat premium plus ceiling paint ultra white #558. pH=8.61

VAL—Valspar white, lot # OW 300108, pH=8.59 (sample supplied by VALSPAR)

HIR—Hirshfield white, pH=8.41 (sample supplied by Quality Paint Products)

### EXAMPLE 2

### Phenolphthalein as Temporary Visual Indicator

A 5 wt % solution of phenolphthalein (PTL) in ethanol was prepared, and 7.20 g of this solution was added to 400.00 g of white latex paint (VAL), and thoroughly mixed. The overall PTL concentration was 0.09%. An aqueous solution of 3M KOH was added drop wise to this mixture, with stirring, until a persistent faint pink color was obtained. This required a total of 4.44 g of KOH solution, and the pH was measured to be 9.95. Then, additional KOH solution was added to give a darker pink color. This required an additional 1.85 g of KOH solution, and resulted in a pH of 10.44. This sample was painted onto a wallboard surface using a brush. After three minutes, the pink color had substantially disappeared. Further addition of KOH solution to achieve a pH of 10.93 did not prolong the duration of the pink color when applied to wallboard. The shortcomings of using PTL as a temporary visual indicator for latex paint are clearly demonstrated. The pH required for color development is too high, and the duration of color persistence after application is very short.

### EXAMPLE 3

### Naptholphthalein as a Temporary Visual Indicator

The method of Example 2 was employed, except that naptholphthalein indicator was used rather than PTL. The total indicator concentration was approximately 0.01%. The pH was adjusted to 10.34 using KOH solution. A blue color was obtained, which fade within two minutes after application. Again, this indicator is clearly not suitable for use as a temporary visual indicator in latex paint formulation.

### EXAMPLE 4

### Phenolphthalein as a Temporary Visual Indicator with pH Modifying Agent

The method of Example 2 was employed. PTL was mixed with 400 g of VAL paint to give a PTL concentration of 0.09%. An alkylalkanolamine (Advantex) manufactured by Atofina Chemicals, Inc, was used to raise pH to 10.18. This required addition of approximately 5.40 g. When painted on a wallboard sample, the color persisted slightly longer than in Example 2 (approximately 5 minutes). This duration is still less than the desired persistence time (15 minutes at least), and requires the addition of considerable volatile organic components. Additionally, the pH of the paint formulation is quite high (over 10).

### EXAMPLE 5

### o-cresolphthalein as a Temporary Visual Indicator

The method of Example 2 was employed. The indicator used was o-cresolphthalein, and the paint used was GLD. A red/pink color was obtained using an indicator concentration of 0.09%, and the pH was adjusted to 10.48 using KOH solution. When painted onto a wallboard surface, the color faded completely in approximately 1 minute.

### EXAMPLE 6

### Phenol Red as a Temporary Visual Indicator

The method of Example 2 was used; however, the indicator was phenol red sodium salt or PRSS (used at a concentration of 0.004 wt %), and the paint used was HIR. The indicator was first dissolved in water, rather than alcohol, to give a 5% working solution. A small amount of 3M KOH solution was added to raise the pH to 8.99. The pink color of the paint persisted for greater than 15 minutes when applied to wallboard, and the dried paint showed a white color. This particular combination was found to work quite well. In general, it was found that a concentration range of PRSS from 0.0005 to 0.01 wt % presented a discemable color for at least 10 minutes up to 180 minutes, and the color from the dye (PRSS) is no longer detectable once the paint is dry.

### EXAMPLE 7

### Bromothymol Blue as a Temporary Visual Indicator

The method of Example 2 was used; however bromothymol blue indicator was used with VAL paint. At a concentration of 0.004%, and a pH of 9.66, obtained using 3M KOH, only a very faint blue color was observed. When painted onto a wallboard surface the blue color fade within 5 minutes, and left a distinct yellow residual color.

### EXAMPLE 8

### m-cresol Purple as a Temporary Visual Indicator

The method of Example 2 was used with the indicator m-cresol purple. The indicator was first dissolved in 3M KOH, rather than alcohol, to give a 2% working solution. This solution (0.90 g) was mixed with 400.00 g VAL paint. The pH was approximately 9.50, and the color faded in less than 3 minutes when applied to wallboard.

### EXAMPLE 9

### BCP as a Temporary Visual Indicator

The same general method as used in the above examples was used. A working solution of 2% bromcresol purple (BCP) indicator was prepared by dissolving 100.00 mg of BCP in 5.00 g of 3M KOH aqueous solution. VAL paint was used (400 g), and 0.74 g of the BCP solution was added. The final pH of this paint was 8.94, and the final BCP concentration was 0.004%. When applied to wallboard, the blue/purple color persisted for longer than 20 minutes, and when finally dry the material had a bright white color.

### EXAMPLE 10

### Stability of pH Indicator/pH Modifier Solutions

The solution of 2% BCP indicator in 3M KOH from Example 9 above was stored for five days. It was found that this solution was no longer able to reproduce the results obtained in Example 9.

Presumably, the very high pH of the 3M KOH solution (>13) caused degradation of the BCP indicator. Thus, such a solution is not suitable for use as a stand-alone additive to be added to paint. Subsequently, it was found that solutions of BCP in solvents such as propylene glycol, dipropylene glycol, or glycerol, were much more stable, and useful for formulation of paint mixtures directly, or as stand-alone indicator concentrate solutions which may be sold for addition by the consumer to the paint of their choice. Additionally, weaker bases such as amines, or carbonates are expected to be more compatible with such concentrates and result in little, if no, degradation of the BCP solution.

### EXAMPLE 11

### Dissipation Rates of BCP

Various paint and BCP indicator mixtures were produced using the methods described above. It was found that a 1% solution of BCP in dipropylene glycol was a very convenient way to utilize the indicator in preparation of these mixtures. Of course, an aqueous solution of the BCP sodium salt is also useful, and has the advantage that less organic solvent must be added to the formulation. It was found that levels of approximately 0.30 to 1.70 g of 1% BCP solution per 400.00 g of paint were most effective, and allowed a range of color intensities and durations to be achieved. This equates to approximately 0.0008 to 0.004 wt % indicator. Various latex paints were used (as described in Example 1).

It was found that there was some variation in the color duration of the BCP when different paints were used but, in general, all formulations showed at least 15 to 30 minutes of color persistence, with some formulations lasting for 24 hours, or longer. Addition of base to raise the pH of the formulation is not absolutely necessary to achieve color or temporary visual indicator performance; however, slightly higher pH levels tend to give longer color duration. Since paint formulations differ, it is expected that a useful range of 0.0005 to 0.01 wt % of temporary visual indicator would present a discemable color in a broad range of different paint formulations for at least 10 minutes up to 180 minutes, where the color imparted from the temporary visual indicator is no longer detectable once the paint is dry.

### EXAMPLE 12

### Light Sensitive and pH sensitive Temporary Visual Indicator

This example demonstrates the use of an indicator that is both pH sensitive, and light sensitive. This formulation may be used alone, or in conjunction with the methods described above.

In particular, the indicator quinoline blue (cyanine) is used. A 1% solution of quinoline blue in ethanol was prepared. Two mL of this was added to 400.00 g VAL paint. No pH modifying agent was used. A light blue color was obtained. Samples were painted onto four identical wallboard substrates. Sample A was placed outside at approximately 65° F. on a bright sunny windy day with low humidity. Sample B was left on a laboratory bench under normal fluorescent lighting. Sample C was stored in a laboratory cabinet in the dark, and Sample D was stored in a dark oven at 60° C.

Sample A turned completely white in approximately 20 minutes. Sample B turned white in approximately 4 hours. Sample D was almost completely white after 6 hours, while Sample C maintained a distinct blue color after 24 hours. Sample C turned white after subsequent exposure to fluorescent light for about 30 minutes.

### EXAMPLE 13

### Performance Characteristics

Stability of paint/indicator mixtures is important, since the paint product may be stored for one year or more prior to being used. Accelerated testing of paint formulations can be accomplished by storing the formulations at elevated temperatures. Thus, sample formulations based on the above examples were stored in a 70° C. oven for various times, and checked for consistency of color and maintenance of temporary visual indicator (TVI) properties.

The material of Example 12, above, was stored for 34 days at 70° C., in a sealed container. Only slight fading of the blue color was observed, and the TVI properties remain unaffected. The material of Example 6, above, was stored for 22 days at 70° C., in a sealed container. Pink color was maintained, as were TVI properties.

Material of Example 11, above, was stored 14 days at 70° C., in a sealed container. The properties of the formulation were not substantially affected by storage at elevated temperatures. These examples indicate that the formulations should have adequate shelf life for use in a commercial product.

### EXAMPLE 14

### Latex Paint Formulations

Knowledge of paint formulation is critical in enabling a dissipation rate of the temporary visual indicator(s) of the invention that is rapid enough to be practical. To demonstrate this, two water based formulas were made and compared. These are both white, interior paints that can be used for ceiling paints. The formulas differ essentially in dispersant and pH modification as shown in Table 1 below. Numbers in parentheses are pounds in a 100 gallon formula. It should not be assumed that all differences in formulation directly relate to dissipation rate.

TABLE 1

| Paint Formulation | Formula A | Formula B |
|---|---|---|
| % PVC | 50.00 | 72.00 |
| % Solids by Weight | 50.70 | 50.50 |
| pH | 9.10 | 8.40 |
| Dispersant | RHODOLINE 111 (9.2) | RHODOLINE 226-35 |
| | (Rhodia, Inc., NJ) | (6.6) |
| | | (Rhodia, Inc., NJ) |
| | | Potassium |
| | | Tripolyphosphate (1.2) |
| pH Modifying Agent | Aminomethyl Propanol | Ammonium Hydroxide |
| | (2.0) | (3.0) |

The latex is vinyl acrylic and pigments are a combination of titanium dioxide, clay, and calcium carbonate. These are the same in both formulas with the amounts adjusted for the difference in % PVC.

The following are dissipation rate results for Formulas A and B, using a BCP dye as the temporary visual indicator (where the BCP presents a blue appearance in initially applied paints). The paints of Formulas A and B were applied over a primed wallboard surface. Note that humidity, temperature, and air movement will affect the dissipation rate.

Formula A demonstrated only slight dissipation (change toward normal paint color) over 24 hours, with only a gradual change over the next 4 days. The color from the BCP dye continues to dissipate over the next two weeks, but leaves an undertone in the dry paint product.

Formula B demonstrated significant dissipation in color within 30 minutes after application, with a majority of color dissipated after 30 minutes. The remaining color is nearly gone in 3 hours after paint application, with trace amounts of color dissipating over the next 12 hours. The color from the BCP dye was no longer detectable with the naked eye after about 12 hours after application?

The unmodified latex paints described in Example 1 exhibit varying shades of white to some extent when compared side-by-side. These range from cooler, with a bluish tint, to warmer, with a more reddish tint. This property is widely known in the paint industry, and is carefully controlled by manufacturers. The TVI formulations described in the above examples may be utilized in order to embellish these properties to some extent. For instance, the PR formulation of Example 6 can be used to impart a slightly warmer tone to the dried paint. Similarly, the BCP formulations of Examples 9 and Example 11 can be used to impart a cooler tone. These tones can be modulated by adjusting the levels of indicators used, by selection of different base paint formulations, or by combining one or more formulations discussed herein.

In certain embodiments, a mixture of BCP and PR together provide an effective temporary visual indicator in latex-based paint products. In one embodiment, a mixture of approximately one (1) part PR with four (4) parts BCP (in the overall concentration range described above) is particularly useful in latex paints in that the synergistic activity of BCP and PR allows a more prominent and visually-appealing first color to be detectable, while minimizing the yellow aftertone which would result from use of PR alone.

In a related embodiment, a 50/50 mixture of PR/BCP is used in latex-based paint products. To help mask any yellow aftertones generated by the PR, additional ingredients such as pigments are added. Further, to enhance temporary visual indicator dissipation rate, ingredients such as KTPP or TKPP at low levels are added. In latex-based paints, the PR can present an easily detectable color so less BCP is needed. Because less BCP is needed in solution, the dissipation time for visible detection of the temporary visual indicators is shorter.

In yet another embodiment of the invention, a 20/80 mixture of BCP/PR is used in latex-based paint products. Such a combination is preferred in that a longer dissipation time is provided.

All patents, patent applications, provisional applications, and publications referred to or cited herein are incorporated by reference in their entirety, including all figures, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A latex-based composition for application to a surface, comprising:
(a) a latex-based material selected from the group consisting of: latex-based paints, stains, epoxies, varnishes, lacquers, and waxes;
(b) at least one pH sensitive visual agent for which a change of pH from a first pH to a second pH causes either (i) a change in the latex-based material's appearance from its original color to a first color that is readily discernable for a period of time and then,to a second color after expiration of the period of time, or (ii) a change in the latex-based material's appearance from its original color to a first color that is readily discernable for a period of time and then back to the original color of the latex-based material after expiration of the period of time.

2. The composition of claim 1, further comprising a pH-modifying substance in an amount sufficient to establish a pH of the composition at said first pH and which evaporates or degrades thereby causing the pH to change to said second pH.

3. The composition of claim 2, wherein the pH-modifying substance is selected from the group consisting of: KOH, aminomethyl propanol, and ammonium hydroxide.

4. The composition of claim 1, wherein the second color of (i) enhances aesthetic appearance of the material.

5. The composition of claim 1, wherein the pH sensitive visual agent is selected from the group consisting of: dibromo-o-cresolfulfonphthalein (BCP); phenolfulfophthalein (PR); cyanine (Qunioline Blue); bromothymol blue; nitrophenol; phenolphthlaein (PTL); naptholphthalein; o-cresolphthalein; bromothymol blue; dibromophenolsulfonphthalein; bromophenol blue; methyl red; bromocresol green; methyl orange; m-cresol purple, and any salt thereof.

6. The composition of claim 1, wherein the latex-based material is a latex-based paint.

7. The composition of claim 6, wherein the pH sensitive visual agent is phenol red sodium salt (PRSS), wherein the pH modifying substance is KOH, and wherein the first pH is about 9.

8. The composition of claim 6, wherein the pH sensitive visual agent is PRSS, wherein the pH modifying substance is an amine or carbonate compound that is weakly basic.

9. The composition of claim 6, wherein the pH sensitive visual agent is BCP, wherein the pH modifying substance is KOH, and wherein the first pH is about 9.

10. The composition of claim 6, wherein the pH sensitive visual agent is BCP, wherein the pH modifying substance is an amine or carbonate compound that is weakly basic.

11. The composition of claim 6, wherein the pH sensitive visual agent is BCP; and wherein the composition contains 0.0005 to 0.01 wt % of BCP.

12. The composition of claim 6, wherein the pH sensitive visual agent is PR, and wherein the composition has a 0.0005 to 0.01 wt % of PR.

13. The composition of claim 6, further comprising a pigment.

14. The composition of claim 13, wherein said pigment is selected from the group consisting of: thermo-optic clays, titanium dioxide, and carbon black.

15. The composition of claim 6, further comprising a wetting agent.

16. The composition of claim 15, wherein the wetting agent is selected from the group consisting of: potassium tripolyphosphate (KTPP); tetrapotassium pyrophosphate (TKPP); RHODOLINE 111; and RHODOLINE 226-35.

17. The composition of claim 1, wherein the pH sensitive visual agent further comprises a solvent.

18. The composition of claim 17, wherein the solvent is selected from the group consisting of: propylene glycol, dipropylene glycol, and glycerol.

19. The composition of claim 1, wherein the pH sensitive visual agent is also sensitive to light.

20. The composition of claim 19, wherein the pH sensitive visual agent is quinoline blue.

21. The composition of claim 1, which comprises two pH sensitive visual agents.

22. The composition of claim 21, wherein the material is a latex paint and the pH sensitive visual agents are nitrophenol and BCP, wherein nitrophenol and BCP work synergistically together to cause either (i) a change in the latex paint's appearance from its original color to a first color that is readily discernable for a period of time and then to a second color after expiration of the period of time, or (ii) a change in the latex paint's appearance from its original color to a first color that is readily discernable for a period of time and then back to the original color of the latex paint after expiration of the period of time.

23. The composition of claim 21, wherein the material is a latex paint and the pH sensitive visual agents are BCP and PR, wherein BCP and PR work synergistically together to cause either (i) a change in the latex paint's appearance from its original color to a first color that is readily discernable for a period of time and then to a second color after expiration of the period of time, or (ii) a change in the latex paint's appearance from its original color to a first color that is readily discernable for a period of time and then back to the original color of the latex paint after expiration of the period of time.

24. A method for preparing a customized latex-based material for application to a surface wherein said method comprises: selecting a material having a first color for application to a surface; assessing user needs; outputting a customized recipe for preparing a customized latex-based material; selecting a pH sensitive visual agent based on the customized recipe; and mixing the visual agent with the material to form the customized material, wherein the visual agent enables the material to present a second color that is different from the first color for a prescribed period of time.

25. The method according to claim 24, further comprising the step of mixing a visibility-modifying substance with the material, wherein the visibility-modifying substance enables the visual agent to be visible for a desired period of time after application.

26. A formulation comprising:
(a) a latex-based paint product selected for application to a surface; and
(b) a temporary visual indicator that is initially visible and capable of imparting a slight tint after application and drying of the formulation to a surface, wherein the temporary visual indicator comprises at least one pH sensitive visual agent and/or a light unstable visual agent.

27. The formulation of claim 26, wherein the latex-based paint is originally white in color before application to a surface and the slight tint enables the latex-based paint to exhibit a “warm white” color after drying.

28. The formulation of claim 26, wherein the latex-based paint is originally white in color before application to a surface and the slight tint enables the latex-based paint to exhibit a “cool white” color after drying.

29. A kit for making a customized formulation for application to a surface, wherein said kit comprises at least one compartment that includes a temporary visual indicator, wherein the temporary visual indicator is initially visible and capable of becoming substantially invisible; and instructions for making the customized formulation.

30. The kit according to claim 29, wherein said indicator is a pH sensitive visual agent or a light unstable visual agent.

31. The kit according to claim 29, further comprising a second compartment that includes a modifying substance, wherein the modifying substance enables the indicator to be visible for a period of time, wherein the period of time the indicator is visible is dependent on the modifying substance mixed with the product; and instructions for mixing the modifying substance.

32. A method for applying a latex-based material to a surface, where the latex-based material is temporarily visible, comprising:
(a) selecting a surface to which a latex-based material is to be applied;
(b) applying to the surface the latex-based material, wherein the latex-based material is selected from the group consisting of: latex-based paints, stains, epoxies, varnishes, lacquers, and waxes; and wherein the latex-based material comprises at least one pH sensitive visual agent for which a change of pH from a first pH to a second pH causes either (i) a change in the latex-based material's appearance from its original color to a first color that is readily discernable for a period of time and then to a second color after expiration of the period of time, or (ii) a change in the latex-based material's appearance from its original color to a first color that is readily discernable for a period of time and then back to the original color of the latex-based material after expiration of the period of time; and
(c) drying the latex-based material.

33. The method of claim 32, wherein the latex-based material is latex-based paint.

34. The method of claim 33, wherein the drying step is selected from the group consisting of: evaporation of a solvent; oxidation and polymerization; evaporation of water and fusion; and chemically catalyzed reaction.
